(19) United States
(12) Patent Application Publication
(10) Pub. No.: US 2026/0280343 A1
(43) Pub. Date: Sep. 17, 2026

(54) ELECTRIC FIELD RESONANT ANTENNA, AND WIRELESS POWER TRANSMISSION SYSTEM

(71) Applicant: NTT, Inc., Tokyo (JP)

(72) Inventor: Takanori WASHIRO, Tokyo (JP)

(21) Appl. No.: 19/156,990

(22) PCT Filed: Mar. 7, 2023
(86) PCT No.: PCT/JP2023/008592

§ 371 Date: Aug. 15, 2025

(51) Int. Cl. H02J 50/00; H02J 50/05

(52) U.S. Cl. CPC H02J 50/005; H02J 50/05

(57) ABSTRACT

An electric field resonant antenna includes: a resonance unit including a first electrode, a second electrode, and a coil connected to the first electrode and the second electrode; and a waterproof case covering the resonance unit.

### TECHNICAL FIELD

The present invention relates to the technical field of wireless power transmission systems.

### BACKGROUND ART

There is a system in which two pairs of electrodes are opposed to each other and power is transmitted in a non-contact manner using capacitive coupling between the electrodes, but in such a system, transmission efficiency drops sharply as a distance between the electrodes increases. Therefore, in order to transmit power wirelessly over a relatively long distance, an electric field resonance method is known that utilizes resonance between transmitting and receiving antennas (see Non-Patent Literature 1).

### CITATION LIST

### Non-Patent Literature

Non-Patent Literature 1: Electric Field Resonant Antenna for Wireless Power Transfer Based on Infinitesimal Dipole, IEEE Wireless Power Transfer Conference (WPTC2021)

### SUMMARY OF INVENTION

### Technical Problem

High transmission efficiency can be achieved by using a wireless power transmission system that uses an electric field resonance method that utilizes resonance between transmitting and receiving antennas. However, this method has a problem that because power is carried using the near field of the electric field, the transmission efficiency drops sharply beyond the range that can be reached by the near field.

The present invention has been made in consideration of the above points, and an object of the present invention is to provide a technology for achieving high transmission efficiency in an electric field resonance method that utilizes resonance between transmitting and receiving antennas, and for extending a transmission distance by expanding a range in which a near field of an electric field that carries power can reach.

### Solution to Problem

According to the disclosed technology, there is provided an electric field resonant antenna including:
a resonance unit including a first electrode, a second electrode, and a coil connected to the first electrode and the second electrode; and
a waterproof case covering the resonance unit.

### Advantageous Effects of Invention

According to the disclosed technology, there is provided a technology for achieving high transmission efficiency in an electric field resonance method that utilizes resonance between transmitting and receiving antennas, and for extending a transmission distance by expanding a range in which a near field of an electric field that carries power can reach.

### BRIEF DESCRIPTION OF DRAWINGS

FIG. 1 is a diagram illustrating an example of a configuration of an electric field resonant antenna 100.

FIG. 2 is a diagram for describing a mechanism of wireless power transmission utilizing resonance.

FIG. 3 is a diagram for describing a mechanism of wireless power transmission utilizing resonance.

FIG. 4 is a diagram illustrating an example of a case where a dielectric 400 is disposed in a wireless power transmission system using an electric field resonance method.

FIG. 5 is a diagram illustrating an example of a case where the dielectric 400 is disposed in the wireless power transmission system using the electric field resonance method.

FIG. 6 is a diagram illustrating a wireless power transmission system according to a first embodiment.

FIG. 7 is a diagram illustrating a wireless power transmission system according to a second embodiment.

FIG. 8 is a diagram illustrating a wireless power transmission system according to the second embodiment.

### DESCRIPTION OF EMBODIMENTS

An embodiment of the present invention (present embodiment) will be described below with reference to the drawings. The embodiments to be described below are merely examples, and embodiments to which the present invention is applied are not limited to the embodiments to be described below.

In the following, first, a mechanism of a conventional wireless power transmission system using an electric field resonance method and the considerations that led to the technology according to the present invention will be described, and then the technology according to the present invention will be described.

Although the conventional wireless power transmission system using the electric field resonance method disclosed in Non-Patent Literature 1 and the like itself is a known technique, the description given in the consideration is not a known technique.

### Mechanism of Wireless Power Transmission System Using Electric Field Resonance Method

A conventional wireless power transmission system using an electric field resonance method transmits power wirelessly by resonating with transmitting and receiving antennas that resonate at a specific frequency through electric field waves propagating through the air.

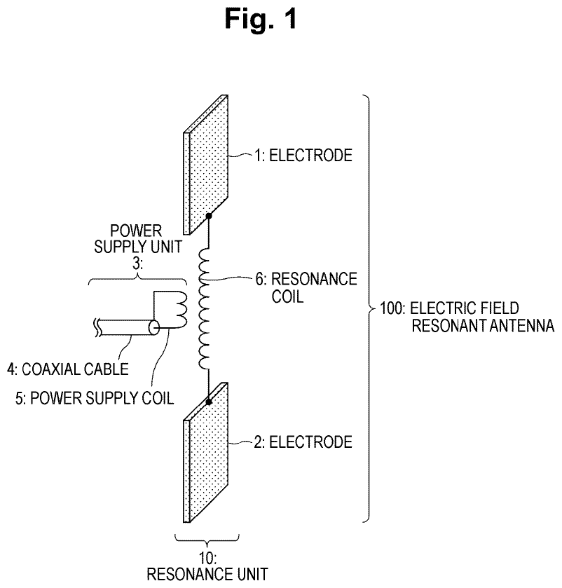

FIG. 1 is a diagram illustrating an example of a configuration of an electric field resonant antenna 100. As illustrated in FIG. 1, this electric field resonant antenna 100 includes a resonance unit 10 designed such that two electrodes 1 and 2 are connected with a resonance coil 6 interposed therebetween and the entire electric length is one-half wavelength, and a power supply unit 3 that is magnetically coupled with the resonance coil 6 and inputs power to the resonance unit 10 or receives power from the resonance unit 10. The power supply unit 3 includes a coaxial cable 4 and a power supply coil 5.

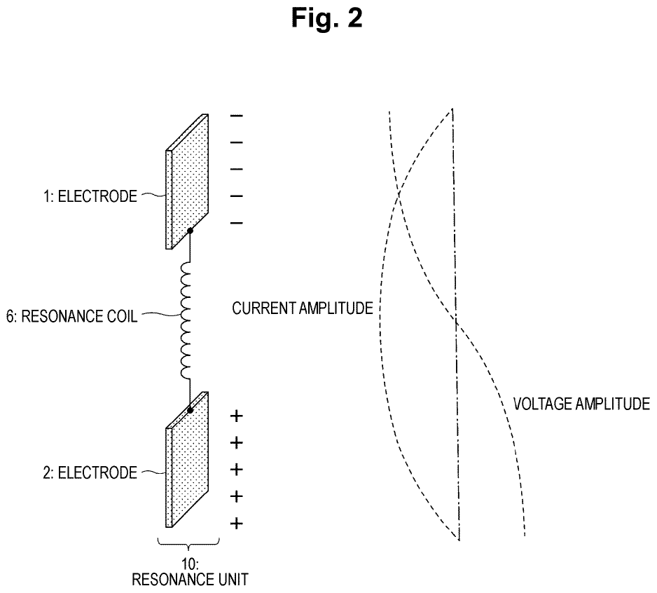

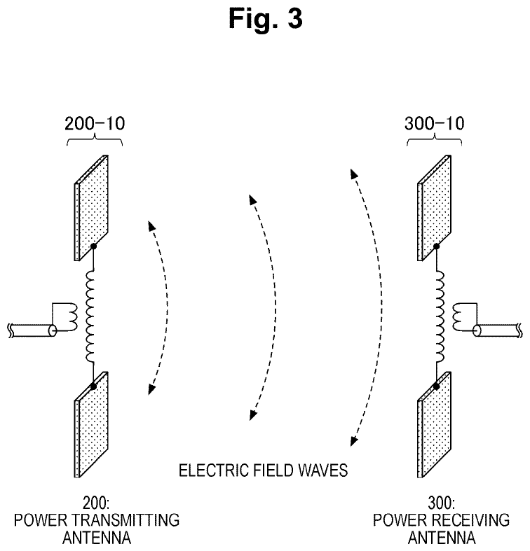

The mechanism of wireless power transmission utilizing resonance will be described with reference to FIGS. 2 and 3. As illustrated in FIG. 2, in the resonance unit 10 of the electric field resonant antenna 100, a standing wave of one-half wavelength is generated and resonates such that a voltage amplitude is the maximum at the electrodes 1 and 2 at both ends and a current amplitude is the maximum at the resonance coil 6 in the center. At this time, charges of the same magnitude but opposite signs accumulate respectively on the two electrodes 1 and 2, creating an electric dipole.

This electric dipole creates electric field waves around it, as illustrated in FIG. 3. The electric field waves transmitted from a power transmitting antenna 200 propagate through the air and reach a power receiving antenna 300, and a resonance unit 300-10 of the power receiving antenna 300 resonates with the electric field waves, thereby enabling highly efficient wireless power transmission.

### Consideration: Use of Dielectric

Electric field waves are created by the vibration of the near field of the electric field around an electric dipole. Since the near field of the electric field is distributed over a range of about ½Π of a wavelength, power cannot be transmitted over distances longer than that.

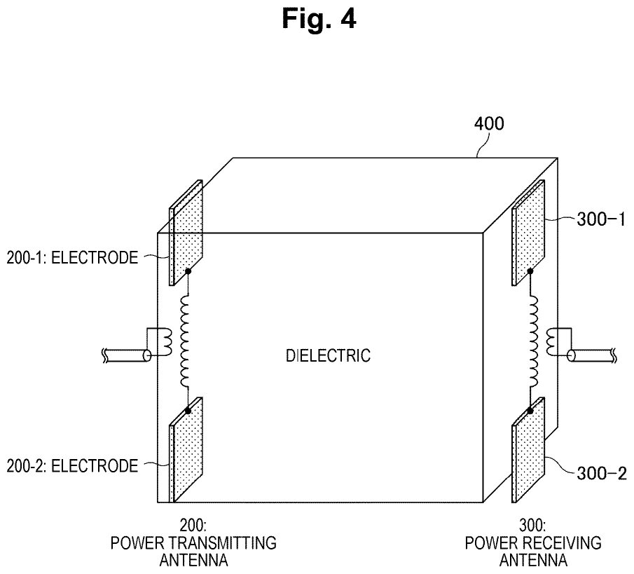

However, a dielectric with a higher dielectric constant than air can serve as a transmission medium for electric field waves, allowing power to travel farther than in air. Therefore, it is considered to place a dielectric between the power transmitting antenna 200 and the power receiving antenna 300 to extend the transmission distance. FIG. 4 is a diagram illustrating an example of a case where a dielectric 400 is disposed in a wireless power transmission system using an electric field resonance method.

The electric field resonant antenna that serves as the power transmitting antenna 200 has two electrodes that accumulate charges of the same magnitude but opposite signs, creating an electric dipole, which resonates as the charges alternate, radiating electric field waves.

However, as illustrated in FIG. 4, if the dielectric 400 is disposed to be close to both electrodes 200-1 and 200-2 of the power transmitting antenna 200, the electrodes 200-1 and 200-2 are short-circuited via the dielectric 400, and resonance is not possible, so that power cannot be transmitted. Similarly, the power receiving antenna 300 also does not operate because two electrodes 300-1 and 300-2 are short-circuited via the dielectric 400. In the following description, when referring to electrodes without making any particular distinction between a power transmitting side and a power receiving side, they will be referred to as an electrode 1, an electrode 2, and the like.

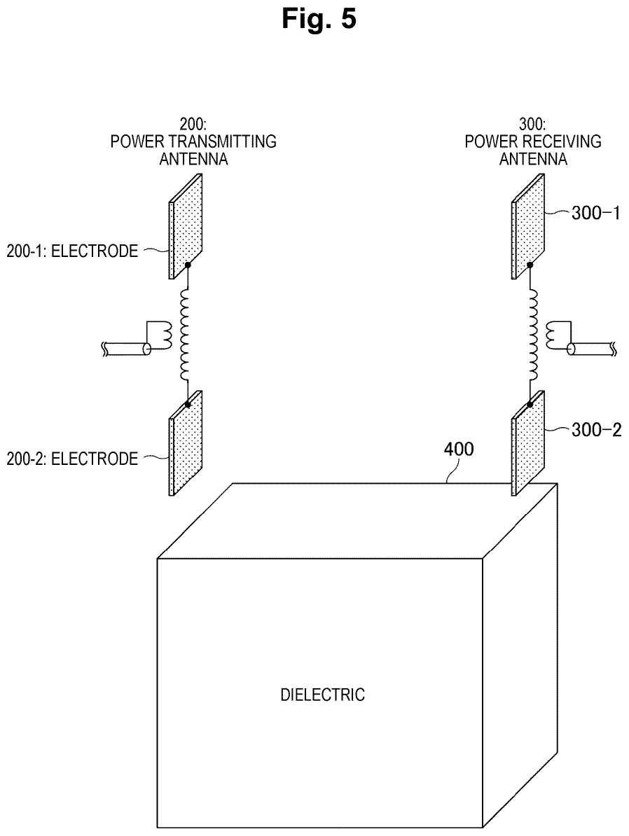

FIG. 5 is a diagram illustrating another example of a case where the dielectric 400 is disposed in the wireless power transmission system using the electric field resonance method.

As illustrated in FIG. 5, if the dielectric 400 is disposed so that it is not close to either the electrode 1 or the electrode 2 of the transmitting and receiving antennas, the electric field waves cannot propagate through the dielectric 400 as a transmission medium, and thus the transmission distance cannot be extended.

### Wireless Power Transmission System According to Embodiment of Present Invention

### First Embodiment

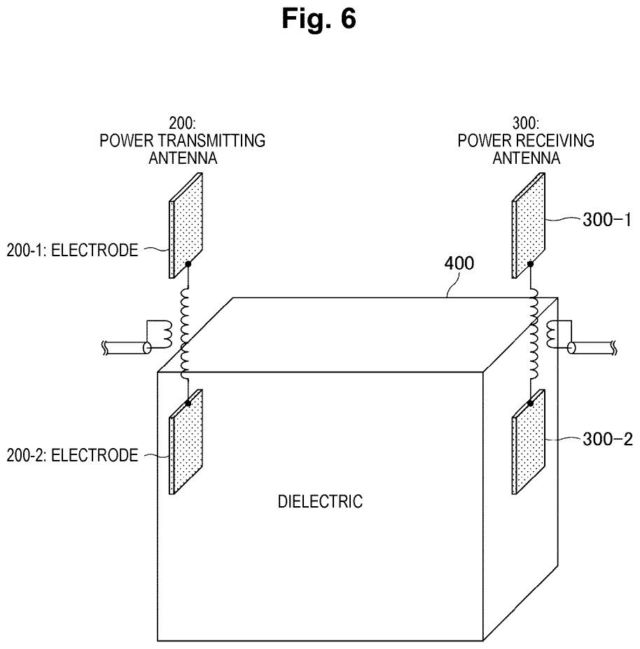

Therefore, in a first embodiment, in each of the transmitting and receiving antennas, only one of a pair of electrodes is disposed to be close to the dielectric 400, as illustrated in FIG. 6. This makes it possible to increase the transmission distance. That is, the electric field waves radiated from the power transmitting antenna 200 propagate a longer distance along the boundary surface between the air and the dielectric 400 than in air.

Now, the dielectric 400, which is the transmission medium that transmits the electric field waves, may be newly installed between the transmitting and receiving antennas for the purpose of wireless power transmission, but it is preferable to use something that is already in place, as this avoids the cost and effort of installing a new dielectric 400. For example, water or seawater, which is the dielectric 400 found around us, can be utilized as a medium for transmitting power.

In the present embodiment (first and second embodiments), the meaning of “water” includes water other than pure water, such as seawater. In addition, in the present embodiment (first and second embodiments), it is assumed that “water” is already present around us, but “water” may be newly prepared for power transmission.

### Second Embodiment

In a case where water is used as a dielectric, it is necessary that only one of the pair of electrodes in each transmitting and receiving antenna is always close to water (the dielectric). In a second embodiment, a configuration for solving this problem will be described.

In the second embodiment, an antenna for wireless power transmission is proposed that incorporates a floating mechanism to maintain the position of the antenna relative to the water near the water surface even if the water level fluctuates due to the influence of waves or the like.

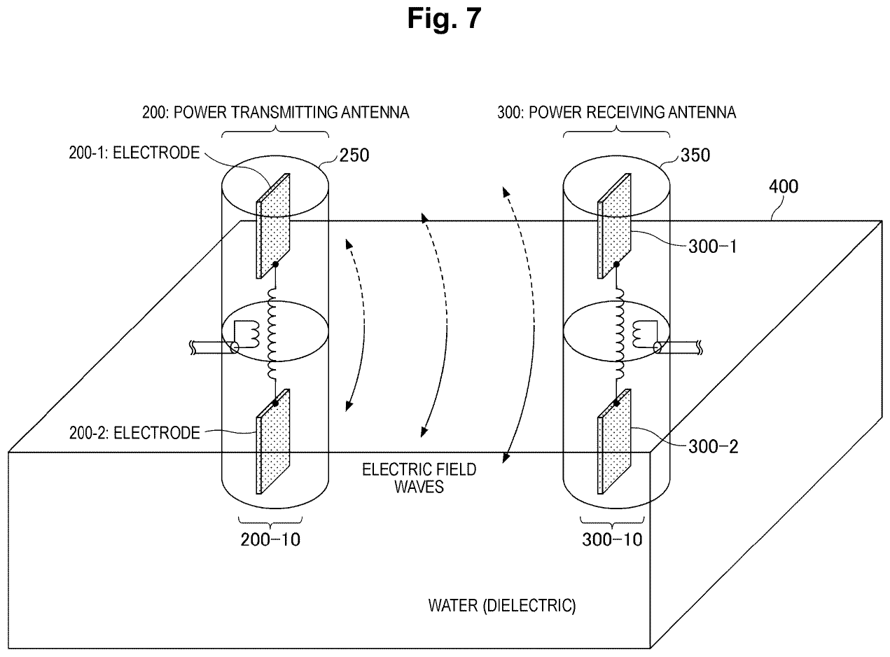

FIG. 7 illustrates an example of a configuration of a wireless power transmission system according to the second embodiment. In the configuration illustrated in FIG. 7, it is assumed that, for example, water found around us (e.g., seawater, river water, pond water, canal water) is used as the dielectric 400.

As illustrated in FIG. 7, in each of the power transmitting antenna 200 and the power receiving antenna 300, the resonance unit 10 is housed in a waterproof case 250/350. In addition, for the waterproof case 250/350 including the resonance unit 10, the specific gravity of the lower electrode 2 of the electrodes 1 and 2 is made higher than that of water, and the specific gravity of the upper electrode 1 is made lower than that of water, so that the vicinity of the center of the resonance unit 10 is always located on the water surface and rises vertically relative to the water surface.

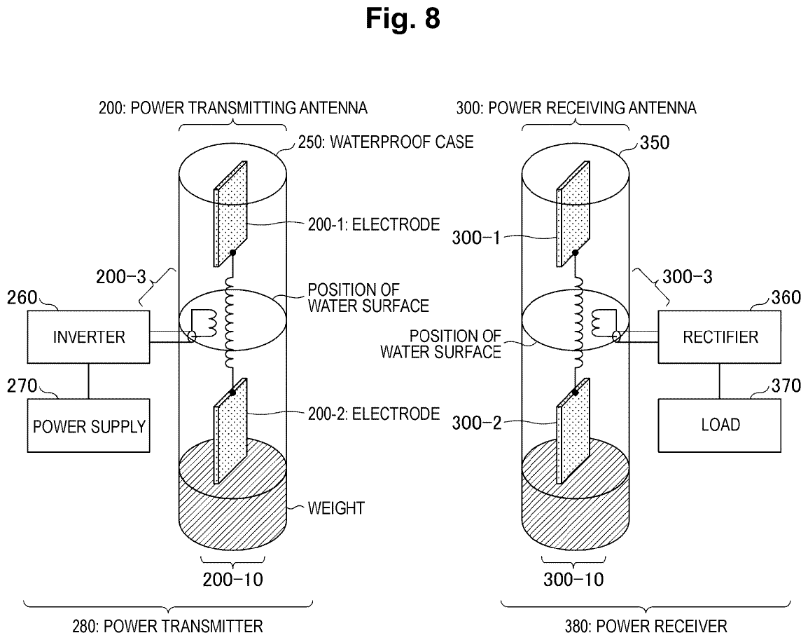

FIG. 8 illustrates an example of a configuration of a wireless power transmission system including a power supply 270 and a load 370 according to the second embodiment. In this wireless power transmission system, power can be transmitted by using water (a dielectric) as a transmission medium. An example of a configuration of a wireless power transmission system according to the second embodiment will be described in more detail with reference to FIG. 8.

As illustrated in FIG. 8, the wireless power transmission system includes a power transmitter 280 and a power receiver 380.

The power transmitter 280 includes a power supply 270, an inverter 260 that converts power into high-frequency power and outputs it, and a power transmitting antenna 200 that rises above the water surface so that half of a resonance unit 200-10 (electrode 200-1) is above water and the other half (electrode 200-2) is submerged in water.

Even in a case where the electrode 200-2 is in a position where it is submerged in water (below the water surface), the electrode 200-2 is not in contact with the water. That is, the resonance unit 200-10 of the power transmitting antenna 200 is placed in a waterproof case 250 made of resin so that the two electrodes 200-1/200-2 are not short-circuited by water. A power supply unit 200-3, the inverter 260, and the power supply 270 are provided outside the waterproof case 250.

A weight such as a metal weight is placed in the waterproof case 250 so that the side of the electrode 200-2 is heavier than the side of the electrode 200-1. Instead of a weight, a dielectric with a high dielectric constant may be filled in around the electrode 200-2 to efficiently transmit the power radiated from the electrode 200-2 to the surrounding water and to adjust the specific gravity of the waterproof case 250 in which the resonance unit 200-10 is placed.

The power receiver 380 includes a power receiving antenna 300 that rises above the water surface so that half of the resonance unit 300-10 (electrode 300-1) is above water and the other half (electrode 300-2) is submerged in water, a rectifier 360 that converts the received high-frequency power into direct current, and a load 370 that uses or stores the received power.

Even in a case where the electrode 300-2 is in a position where it is submerged in water (below the water surface), the electrode 300-2 is not in contact with the water. That is, the resonance unit 300-10 of the power receiving antenna 300 is placed in a waterproof case 350 made of resin so that the two electrodes 300-1/300-2 are not short-circuited by water. A power supply unit 300-3, the rectifier 360, and the load 370 are provided outside the waterproof case 350.

A weight such as a metal weight is placed in the waterproof case 350 so that the side of the electrode 300-2 is heavier than the side of the electrode 300-1. Instead of a weight, a dielectric with a high dielectric constant may be filled in around the electrode 300-2 to adjust the specific gravity of the waterproof case 350 in which the resonance unit 300-10 is placed.

With the configuration illustrated in FIG. 8, it is possible to efficiently supply power wirelessly to sensors, communication devices, and the like floating on the water.

### Variations

Regarding the material of the waterproof case 250/350, a material other than resin may be used as long as it is a material that does not cause a short circuit even in a case where two electrodes come into contact with the inner wall of the waterproof case 250/350.

Furthermore, the shape of the waterproof case 250/350 is not limited to the cylindrical shape shown in FIGS. 7 and 8. For example, it may be a rectangular parallelepiped or a sphere. In either case of a rectangular parallelepipedor a sphere, a weight (or a dielectric that serves as a weight) is disposed at the bottom thereof to prevent it from becoming unstable when floated on water.

Furthermore, the waterproof case 250 on the power transmitting side and the waterproof case 350 on the power receiving side may be different in shape or material.

Furthermore, the weight to be disposed at the bottom of the waterproof case 250/350 may be any weight as long as the weight has a specific gravity greater than that of water. Also, instead of or in addition to disposing a weight (or a dielectric that serves as a weight), the metal plate of the lower electrode 2 may be thickened to make the lower electrode 2 heavier than the upper electrode 1.

Furthermore, the dielectric to be disposed as a weight at the bottom of the waterproof case 250/350 may be any dielectric as long as the dielectric has a specific gravity greater than that of water and a dielectric constant greater than that of air. For example, ceramic, glass epoxy resin, or the like can be used.

Also, there may be cases where it is not necessary to dispose a weight (or a dielectric that serves as a weight) in the waterproof case 250/350. For example, in a case where the waterproof case 250/350 can be fixed (e. g., fixed to a pier at a harbor) so that the electrode 2 is in a position submerged in water, a weight may not be disposed.

### SUMMARY OF EMBODIMENTS AND EFFECTS

As described above, in the present embodiment, an electric field resonant antenna is realized in which the entire resonance unit including two electrodes and a coil connected thereto is covered in a waterproof case. In the electric field resonant antenna, the specific gravity of the side on which one of the two electrodes is installed is greater than the specific gravity of the side on which the other electrode is installed. Therefore, when the electric field resonant antenna is floated on water, one electrode is submerged below the water surface and the other electrode rises vertically above the water surface and floats on the water surface.

Furthermore, by using the above-mentioned electric field resonant antenna for power transmission and reception, a wireless power transmission system that transmits power wirelessly along the water surface is realized.

With the wireless power transmission system according to the present embodiment, it is possible to achieve high transmission efficiency by using an electric field resonance method that utilizes the resonance between the transmitting and receiving antennas, and at the same time, it is possible to extend the transmission distance by expanding the range in which the near field of the electric field that carries the power can reach.

This makes it possible to wirelessly supply power to marine sensors, observation devices, or the like where it is difficult to install cables.

Regarding the above embodiments, the following supplementary notes are further disclosed.

### Supplementary Notes

### (Supplementary Note 1)

An electric field resonant antenna including:
a resonance unit including a first electrode, a second electrode, and a coil connected to the first electrode and the second electrode; and
a waterproof case covering the resonance unit.

### (Supplementary Note 2)

The electric field resonant antenna according to Supplementary Note 1, in which,
when the electric field resonant antenna is floated on water, the second electrode is located below a water surface, and the first electrode rises above the water surface and floats on the water surface.

### (Supplementary Note 3)

The electric field resonant antenna according to Supplementary Note 1 or 2, in which
a specific gravity of a side on which the second electrode is installed is greater than a specific gravity of a side on which the first electrode is installed.

### (Supplementary Note 4)

The electric field resonant antenna according to any one of Supplementary Notes 1 to 3, including
a weight or a dielectric that serves as a weight inside the waterproof case.

### (Supplementary Note 5)

A wireless power transmission system including the electric field resonant antenna according to any one of Supplementary Notes 1 to 4 on each of a power transmitting side and a power receiving side.

Although the present embodiments have been described above, the present invention is not limited to such a specific embodiment, and various modifications and changes can be made within the scope of the gist of the present invention described in the claims.

### REFERENCE SIGNS LIST

1, 2 Electrode
3 Power supply unit
4 Coaxial cable
5 Power supply coil
6 Resonance coil
10 Resonance unit
100 Electric field resonant antenna
200 Power transmitting antenna
250 Waterproof case
260 Inverter
270 Power supply
280 Power transmitter
300 Power receiving antenna
350 Waterproof case
360 Rectifier
370 Load
380 Power receiver

1. An electric field resonant antenna comprising:
a resonator including a first electrode, a second electrode, and a coil connected to the first electrode and the second electrode; and
a waterproof case covering the resonator.

2. The electric field resonant antenna according to claim 1, wherein,
when the electric field resonant antenna is floated on water, the second electrode is located below a water surface, and the first electrode rises above the water surface and floats on the water surface.

3. The electric field resonant antenna according to claim 1, wherein
a specific gravity of a side on which the second electrode is installed is greater than a specific gravity of a side on which the first electrode is installed.

4. The electric field resonant antenna according to claim 1, comprising
a weight or a dielectric that serves as a weight inside the waterproof case.

5. A wireless power transmission system comprising the electric field resonant antenna according to claim 1 on each of a power transmitting side and a power receiving side.
